(19) United States
(12) Patent Application Publication
(10) Pub. No.: US 2019/0091601 A1
(43) Pub. Date: Mar. 28, 2019

(54) BEER DEGASSING APPARATUS AND SYSTEM

(71) Applicant: Vogelbusch USA Inc., Katy, TX (US)

(72) Inventor: Anthony Kenneth Varnas, Katy, TX (US)

(73) Assignee: Vogelbusch USA Inc., Katy, TX (US)

(21) Appl. No.: 15/719,143

(22) Filed: Sep. 28, 2017

(51) Int. Cl. B01D 3/14; B01D 3/00; B01D 5/00; B01D 19/00

(52) U.S. Cl. CPC B01D 3/143; B01D 3/001; B01D 19/00; B01D 5/006; B01D 5/0069; B01D 3/007

(57) ABSTRACT

An apparatus and method for removing carbon dioxide gas from beer. The apparatus includes a preheater, a degas column, a degas condenser, an optional degas condensate receiver, an optional degas condensate pump, and a bottoms pump. The apparatus is arranged to receive a feed from a beer source into the preheater and output the heated beer in the degas column. Much of the vapor in the degas column is condensed to a liquid phase by the degas condenser, and residual vapor is directed to-an existing carbon dioxide scrubber. The liquid phase is then reintroduced to the degas column via the degas condensate receiver and degas condensate pump. The degassed beer is pumped from the bottom of the degas column, through the beer preheater, and finally on to the existing distillation system.

### BACKGROUND OF THE DISCLOSURE

### 1. Field of the Disclosure

This disclosure relates to the field of ethanol production and, more specifically, removal of carbon dioxide prior to ethanol distillation.

### 2. Description of the Related Art

Ethanol can be produced when a mash is fermented, resulting in an ethanol-rich “beer” that is saturated with carbon dioxide (CO₂). In a typical ethanol distillation, ethanol is stripped from a beer feed in a beer column, and the ethanol/water mixture is concentrated to a ratio near the azeotropic point in a rectifying column. The remaining water can then be removed using molecular sieve or other drying technology.

A shortcoming of some prior art distillation systems is the tendency of these systems to have an unnecessary load on the beer column due to the presence of carbon dioxide in the beer feed. This carbon dioxide-rich beer requires more energy to process in the beer column than beer that does not contain high concentrations of carbon dioxide.

Another shortcoming of the prior art is a lower heat transfer coefficient in the rectifying column overhead condenser when carbon dioxide is present in the mixture.

Another shortcoming of the prior art is the requirement of a vacuum pump sized to handle the additional carbon dioxide in the carbon dioxide-rich beer, as well as, the associated power requirements of running an oversized vacuum pump.

Another shortcoming of the prior art is high acidity ethanol being produced by the presence of carbon dioxide, which may require the later implementation of a flashing process to remove the dissolved carbon dioxide to meet ethanol acidity specifications.

What is needed is an apparatus and method for removing carbon dioxide dissolved in the beer prior to the beer column to reduce the energy requirements, improve heat transfer in the rectifying column overhead condenser, reduce the size of the vacuum pump, and reduce the production of high acidity in the product ethanol.

### BRIEF SUMMARY OF THE DISCLOSURE

In aspects, the present disclosure is related to systems and apparatuses for providing degassed beer, specifically for removal of carbon dioxide prior to feeding ethanol distillation systems.

One embodiment according to the present disclosure includes a degassing apparatus comprising: a preheater; a degas column configured to contain beer and having a top and a bottom, wherein the preheater is in fluid communication with the top of the degas column; a degas condenser in fluid communication with top of the degas column; a condensate receiver in fluid communication with the degas condenser; a degas condensate pump in fluid communication with the condensate receiver and the top of the degas column; and a first pump in fluid communication with the bottom of the degas column and configured to pump fluid from the bottom of the degas column to the preheater. The apparatus may include a second pump in fluid communication with the bottom of the degas column; and a reboiler in fluid communication with the second pump and the bottom of the degas column; wherein the second pump is configured to circulate fluid between the bottom of the degas column and the reboiler.

Another embodiment according to the present disclosure includes a degassing system for ethanol distillation, comprising: a beer column with an inlet and an outlet; a degassing module comprising: a preheater with a first line with an inlet and an outlet and a second line with an inlet and an outlet, wherein the first line inlet is in fluid communication with the beer column outlet and a second line outlet is in fluid communication with the beer column inlet; a degas column configured to contain beer and having a top and a bottom, wherein the first line outlet is in fluid communication with the top of the degas column; a degas condenser in fluid communication with top of the degas column; a condensate receiver in fluid communication with the degas condenser; a degas condensate pump in fluid communication with the condensate receiver and the top of the degas column; and a first pump in fluid communication with the bottom of the degas column and configured to pump fluid from the bottom of the degas column to the second line inlet of the preheater; a carbon dioxide scrubber in fluid communication with the degas condenser; and a heat source in thermal communication with the bottom of the degas column. The heat source in thermal communication with the bottom of the degas column may include a steam source in fluid communication with the bottom of the degas column. The heat source in thermal communication with the bottom of the degas column may include a second pump in fluid communication with the bottom of the degas column; and a reboiler in fluid communication with the second pump and the bottom of the degas column; and a steam source in fluid communication with the reboiler; wherein the second pump is configured to circulate fluid between the bottom of the degas column and the reboiler.

Another embodiment according to the present disclosure may include a degassing apparatus comprising: a preheater; a degas column configured to contain beer and having a top and a bottom, wherein the preheater is in fluid communication with the top of the degas column; a degas condenser in fluid communication with the top of the degas column and disposed above the top of the degas column; and a first pump in fluid communication with the bottom of the degas column and configured to pump fluid from the bottom of the degas column to the preheater. The apparatus may also include a second pump in fluid communication with the bottom of the degas column; and a reboiler in fluid communication with the second pump and the bottom of the degas column; wherein the second pump is configured to circulate fluid between the bottom of the degas column and the reboiler.

Another embodiment according to the present disclosure may include a degassing system for ethanol distillation, comprising: a beer column with an inlet and an outlet; a degassing module comprising: a preheater with a first line with an inlet and an outlet and a second line with an inlet and an outlet, wherein the first line inlet is in fluid communication with the beer column outlet and a second line outlet is in fluid communication with the beer column inlet; a degas column configured to contain beer and having a top and a bottom, wherein the first line outlet is in fluid communication with the top of the degas column; a degas condenser in fluid communication with the top of the degas column and disposed above the top of the degas column; and a first pump in fluid communication with the bottom of the degas column and configured to pump fluid from the bottom of the degas column to the second line inlet of the preheater; a carbon dioxide scrubber in fluid communication with the degas condenser; and a heat source in thermal communication with the bottom of the degas column. The heat source in thermal communication with the bottom of the degas column may include a steam source in fluid communication with the bottom of the degas column. The heat source in thermal communication with the bottom of the degas column may include a second pump in fluid communication with the bottom of the degas column; and a reboiler in fluid communication with the second pump and the bottom of the degas column; and a steam source in fluid communication with the reboiler; wherein the second pump is configured to circulate fluid between the bottom of the degas column and the reboiler.

Another embodiment according to the present disclosure includes a method for degassing beer, comprising the steps of: heating beer a preheater; separating the beer into vapor and liquid phases in a degas column, the degas column having a top and a bottom; removing the vapor phase from the top of the degas column to a degas condenser; condensing a part of the vapor phase in the degas condenser; returning the condensed part of the vapor phase to the top of the degas column; removing the uncondensed part of the vapor phase to a carbon dioxide scrubber; pumping the liquid phase from the bottom of the degas column to the preheater; extracting heat from the liquid phase the preheater; and adding heat to the bottom of the degas column of the degas column. The step of returning the condensed part of the vapor phase to the top of the degas column may include collecting the condensed part of the vapor phase from the degas condenser in a condensate receiver; and pumping the condensed part of the vapor phase from the condensate receiver to the top of the degas column. The step of adding heat to the bottom of the degas column may include adding steam to the bottom of the degas column. The step of adding heat to the bottom of the degas column may include adding steam to a reboiler; circulating liquid between the bottom of the degas column and the reboiler; and removing condensed water from the reboiler.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

A better understanding of the present disclosure can be obtained with the following detailed descriptions of the various disclosed embodiments in the drawings, which are given by way of illustration only, and thus are not limiting the present disclosure, and wherein:

FIG. 1 shows a diagram of the beer degassing system using a reboiler as a heat source according to one embodiment of the present disclosure;

FIG. 2 shows a diagram of another configuration of the beer degassing system using direct steam according to the present disclosure;

FIG. 3 shows a diagram of another configuration of the beer degassing system with a degas condenser disposed above a degas column and a reboiler as a heat source according to one embodiment of the present disclosure;

FIG. 4 shows a diagram of another configuration of the beer degassing system with a degas condenser disposed above the degas column and using direct steam according to the present disclosure;

FIG. 5 shows a flow chart of a method of degassing beer using the degassing module of FIG. 1 or FIG. 3; and

FIG. 6 shows a flow chart of a method of degassing beer using the degassing module of FIG. 2 of FIG. 4.

While the inventions disclosed herein are susceptible to various modifications and alternative forms, only a few specific embodiments are shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art, and to enable such persons to make and use one or more of the inventive concepts.

### DETAILED DESCRIPTION OF THE DISCLOSURE

In aspects, the present disclosure is related to as system for degassing beer prior to an ethanol distillation process. Specifically, the present disclosure is related to removal of carbon dioxide using an apparatus in communication with a beer processing system. The present invention is susceptible to embodiments of different forms. There are shown in the drawings, and herein will be described in detail, specific embodiments with the understanding that the present invention is to be considered an exemplification of the principles and is not intended to limit the present invention to that illustrated and described herein.

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation from time to time. While a developer's efforts might be complex and time consuming, such efforts would be, nevertheless, a routine undertaking for those of ordinary skill in the art having the benefit of this disclosure.

Accordingly, it is an object of the present disclosure to reduce the amount of carbon dioxide in beer (i.e. degas the beer) prior to an ethanol distillation process, specifically, before processing of beer in a beer column. Degassing the beer reduces the load on the existing beer column. This load can translate into a reduction in the amount of energy consumed at a given feed rate or allow the existing beer column to handle an increased feed rate (capacity) for a given beer column diameter.

Removing carbon dioxide from the beer increases the capacity of existing distillation equipment by reducing the load and energy that would be otherwise used to handle the carbon dioxide dissolved in the beer. Exemplary improvements include, but are not limited to, increasing the capacity of an existing rectifying column overhead condenser by improving the heat transfer coefficient, improving the log mean temperature difference of the condenser, and decreasing the vapor flow to the condenser. The removal of carbon dioxide also reduces the load on vacuum pumps in distillation systems configured to operate under vacuum because carbon dioxide dissolved in beer is released and then removed with a vacuum pump. The absence of carbon dioxide in a vacuum system means that the same amount of degassed beer can be processed with a smaller, lower energy vacuum pump and reduced seal water requirements to maintain the vacuum.

While apparatuses and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

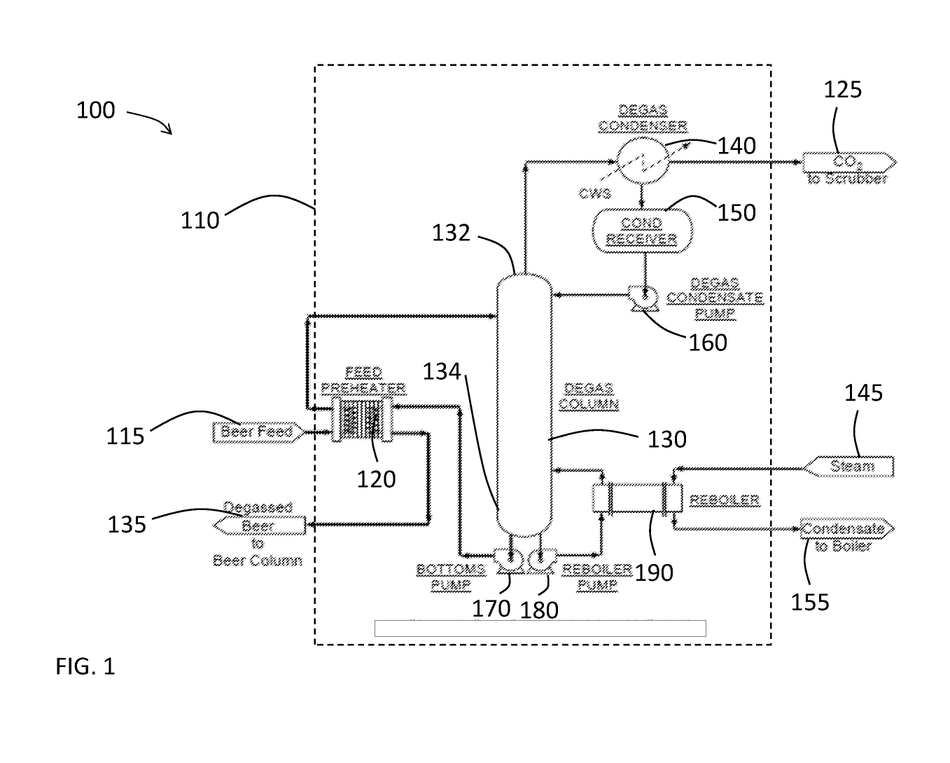

FIG. 1 shows the beer degassing system 100 with a beer degassing module 110. A beer source or feed 115 supplies an ethanol-containing “beer” mixture with dissolved carbon dioxide to the degassing module 110, to which it is in fluid communication. The degassing module 110 is also in fluid communication with the existing carbon dioxide scrubber 125, which is configured to separate ethanol from carbon dioxide in uncondensed vapors. Steam is supplied from a steam source 145, such as a boiler, to the degassing module 110 and condensate from the degassing module 110 is either returned to the boiler or returned to the process for reuse and/or disposal. The degassed beer from the degassing module 110 is pumped to the existing beer column.

The degassing module 110 includes a feed preheater 120, a degas column 130 with trays, a degas condenser 140, a degas condensate receiver 150, a degas condensate pump 160, a bottoms pump 170, a reboiler pump 180, and a reboiler 190. The feed preheater 120 is in fluid communication with the beer feed 115 and the degas column 130. The feed preheater 120 is configured to heat the beer supplied by the beer source 115 with heat from the bottom 134 of the degas column 130 and output the heated beer to the degas column 130. In some embodiments, the beer is preheated. In some embodiments, the beer is heated and pressurized to remain liquid in the degas column 130. In some embodiments, the beer is heated to a temperature above the flash temperature of the beer, which may vary based on the composition of the beer. In some embodiments, the feed preheater 120 includes one or more wide gap plate heat exchangers suitable for liquids with entrained solids, as would be understood by a person of ordinary skill in the art. When multiple heat exchanges are present, the heat exchangers may be arranged in parallel so that at least one heat exchange may remain operations while another is shut down for cleaning or maintenance. Each of the heat exchangers may be sized to receive full capacity from the feed of the beer source 115. The degas column 130 is in fluid communication with the degas condenser 140. The degas column 130 may include a standard distillation column. In some embodiments, the degas column 130 may include stripping trays and be configured for typical beer feeds. In some embodiments, the degas column 130 may include fixed valve stripping trays. The heated beer from the preheater 120 is introduced to the top 132 of the degas column 130 of the degas column 130, but much of the heated beer descends into a bottom 134 of the degas column 130 of the degas column 130 due to gravity. The carbon dioxide with some ethanol and water from the heated beer escapes the liquid phase of the heated beer as a vapor and exits the top 132 of the degas column 130 at a controlled rate. The degas condenser 140 is in fluid communication with the existing carbon dioxide scrubber 125 and the degas condensate receiver 150. The degas condenser 140 is configured to remove heat from the vapor exiting the top 132 of the degas column 130 so at least part of the vapor condenses into a liquid phase. The remaining vapor, largely carbon dioxide and ethanol, is routed to the carbon dioxide scrubber 125 for ethanol recovery. The degas condensate receiver 150 is in fluid communication with the degas condensate pump 160. The degas condensate receiver 150 receives the condensed liquid from the degas condenser 140 so that it may be pumped back into the degas column 130. The degas condensate pump 160 is in fluid communication with the degas column 130 and pumps the liquid phase into the degas column 130. In some embodiments, the degas condensate pump 160 may include a centrifugal pump; however, this is exemplary and illustrative only, as other suitable pumps may be used. The degas column 130, degas condenser 140, degas condensate receiver 150, and degas condensate pump 160 form a loop.

The degas column 130 is also in fluid communication with the reboiler 190 and the reboiler pump 180, and these three components form a reboiler loop. The reboiler 190 and reboiler pump 180 are located at the bottom 134 of the degas column 130 so that the circulated feed is liquid from the degas column 134 rather than vapor, which accumulates near the top 132 of the degas column 130. The degas column 130 is in fluid communication with the bottoms pump 170, which is in fluid communication with the feed preheater 120. The feed preheater 120 is in fluid communication with the degassed beer line 135.

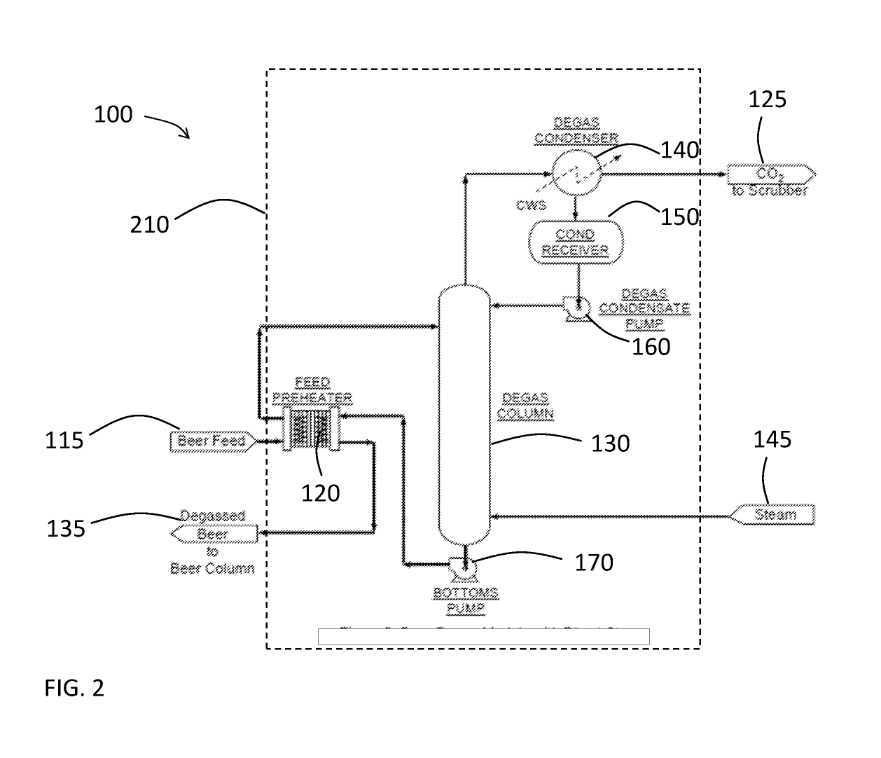

FIG. 2 shows a variation of the beer degassing system 100 that uses direct steam instead of the reboiler 190 to heat the degas column 130 in the beer degassing module 110. The degas column 130 is in direct fluid communication with the steam source 145, and the degassing module 210 does not include the reboiler 190 or the reboiler pump 180.

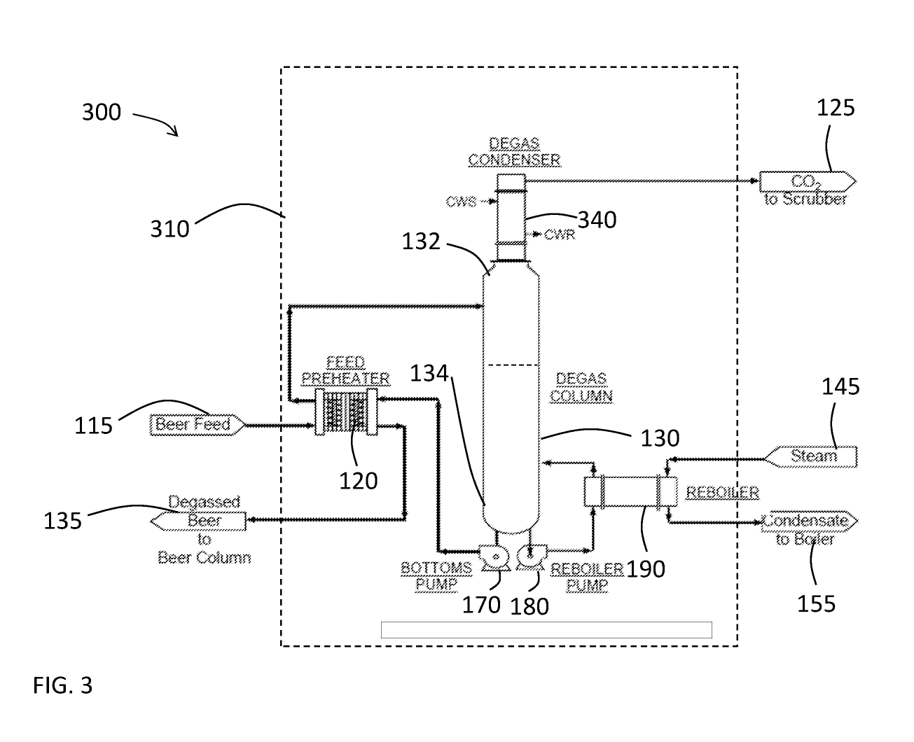

FIG. 3 shows a beer degassing system 300 that is a variation of the beer degassing system 100 of FIG. 1 where beer degassing module 310 similar to the beer degassing module 110 includes a degas condenser 340 that directly returns condensed liquid to the top 132 of the degas column 130 of the degas column 130. In some embodiments, the degas condenser 340 may be disposed above the degas column 130. The degas condenser 340 is similar in function to the degas condenser 140; however, the vapor rising into the degas condenser 340 may be condensed and returned, minus some or all of the carbon dioxide, to the degas column 130 directly rather than the condensed vapor being accumulated the condensate receiver 150 and pumped back to the degas column 130 with the degas condensate pump 160 as in FIG. 1. Thus the return of the degas condensate from the vapor to the degas column 130 can be performed passively using gravity rather than actively using the degas condensate pump 160.

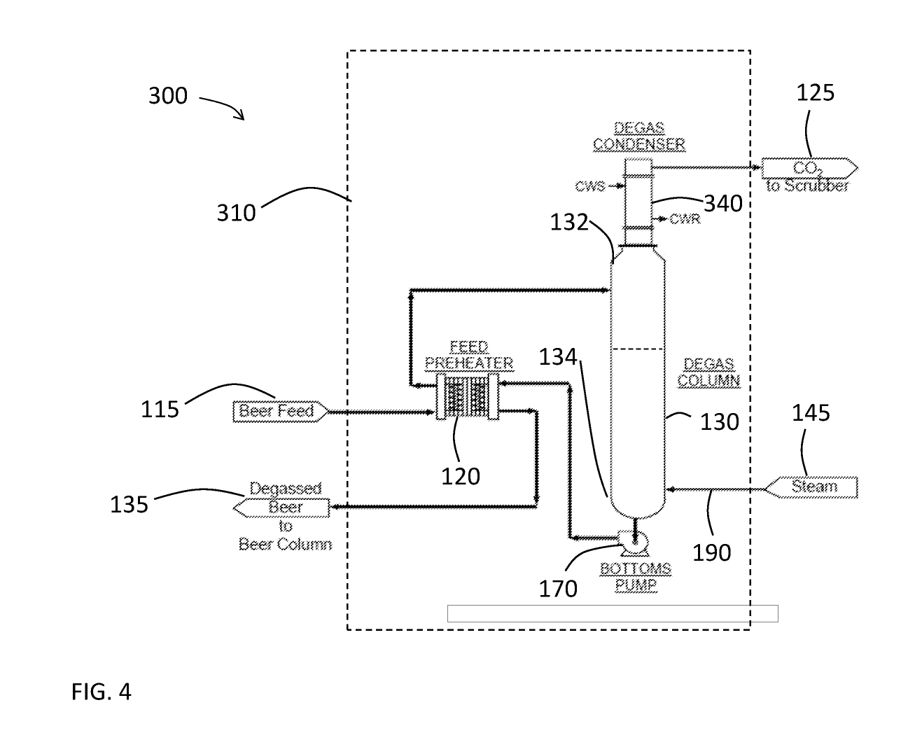

FIG. 4 shows a variation of the beer degassing system 300 that uses direct steam instead of the reboiler 190 to heat the degas column 130 of the beer degassing module 310. The degas column 130 is in direct fluid communication with the steam source 145, and the degassing module 210 does not include the reboiler 190 or the reboiler pump 180.

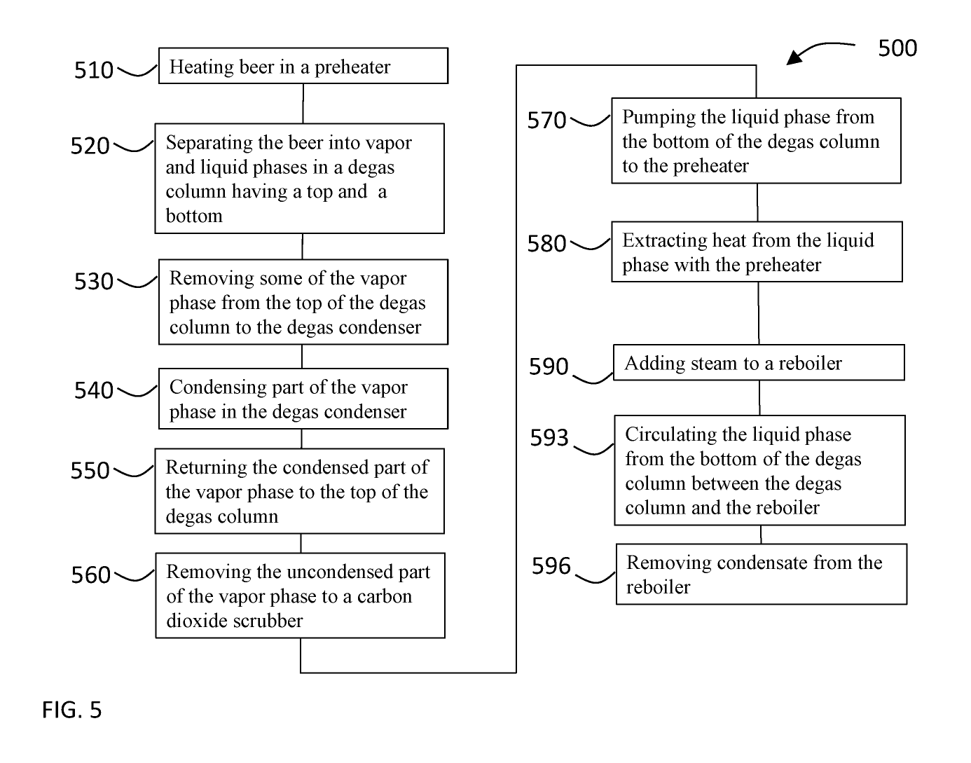

FIG. 5 shows a flow chart of a method 500 for operating the degas module 110 or the degas module 310. In step 510, beer from the beer source 115 is heated in the beer preheater 120 using heat from degassed beer exiting the bottom 134 of the degas column 130. In step 520, the heated beer is separated in the degas column 130 into vapor and liquid phases. The vapor phase migrates to the top 132 of the degas column 130 and the liquid phase migrates to the bottom 134 of the degas column 130 due to gravity. In step 530, the vapor phase is removed from the top 132 of the degas column 130 to the degas condenser 140. In step 540, the vapor phase is condensed in the degas condenser 140 (FIGS. 1 and 2) or the degas condenser 340 (FIGS. 3 and 4) such that part of the vapor phase becomes liquid and part remains in a vaporous state. In step 550, the condensed liquid is returned to the top 132 of the degas column 130. In some embodiments, the beer degassing module 110 may be configured to collect the condensed liquid in the degas condensate receiver 150 and pump the condensed liquid back into the top 132 of the degas column 130 using the degas condensate pump 160. In some embodiments, the beer degassing module 310 may be configured to return the condensed liquid to the top 132 of the degas column 130 by way of gravity. In step 560, the uncondensed part from the degas condenser is removed to an existing carbon dioxide scrubber and the carbon dioxide is separated from the ethanol. In step 570, the liquid phase from the bottom 134 of the degas column 130 (now degassed beer) is pumped to the beer preheater 120. In step 580, heat is removed from the degassed beer by the beer preheater 120 and the degassed beer is reintroduced the existing beer column via a degassed beer line 135. In step 590, heat is added to the degas column 130 to separate the carbon dioxide from the beer. Steps 590 through 596 take place continuously and in parallel with steps 510 through 580. In step 590, steam from the steam source 145 adds heat to the reboiler 190. In step 593, the reboiler pump 180 circulates beer from the bottom 134 of the degas column 130 between the reboiler 190 and the bottom 134 of the degas column 130 so that the beer is heated by the steam in the reboiler 190. In step 596, condensate from the reboiler is returned through a drain line 155.

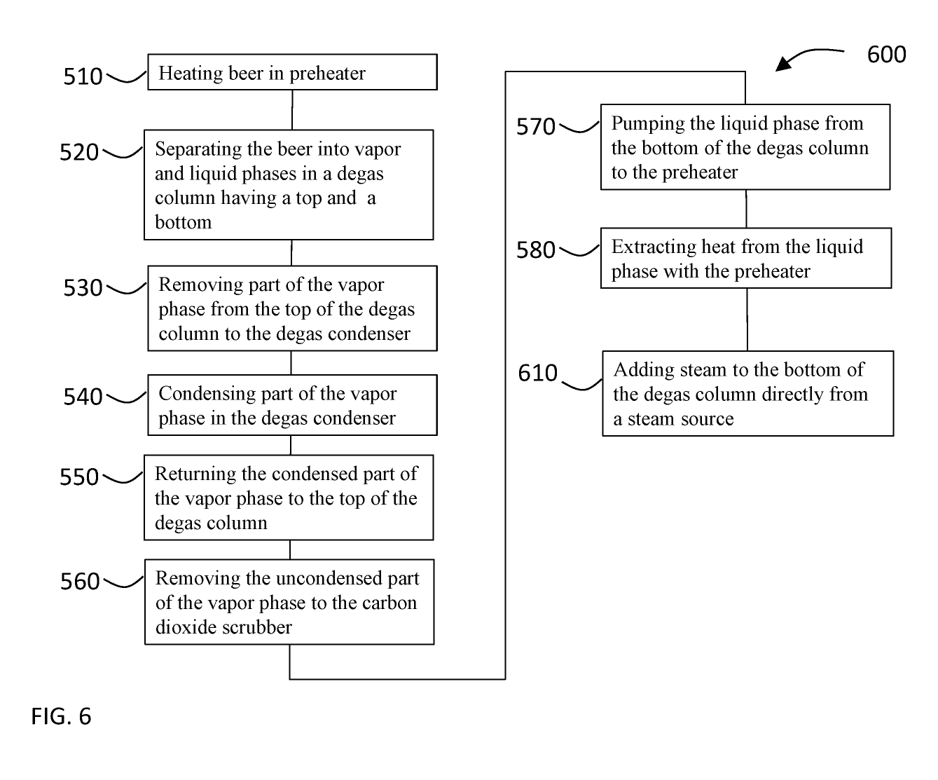

FIG. 6 shows a flow chart for a method 600 for degassing beer using direct steam as shown in FIG. 2. Steps 510-580 are the same as in method 500; however, steps 590, 593, and 596 are replaced by step 610 as follows. In step 610, heated steam is directly introduced to the bottom 134 of the degas column 130 from a steam source 145.

All of the apparatuses disclosed and claimed herein can be made and executed without undue experimentation in light of the present disclosure. While the methods and apparatus of this invention have been described in terms of preferred embodiments, it will be apparent to those of skill in the art that variations may be applied to the methods, processes and/or apparatus and in the steps or in the sequence of steps of the methods described herein without departing from the concept and scope of the invention. More specifically, it will be apparent that certain features which are both mechanically and functionally related can be substituted for the features described herein while the same or similar results would be achieved. All such similar substitutes and modifications apparent to those skilled in the art are deemed to be within the scope and concept of the invention.

While embodiments in the present disclosure have been described in some detail, according to the preferred embodiments illustrated above, it is not meant to be limiting to modifications such as would be obvious to those skilled in the art.

The foregoing disclosure and description of the disclosure are illustrative and explanatory thereof, and various changes in the details of the illustrated apparatus and system, and the construction and the method of operation may be made without departing from the spirit of the disclosure.

What is claimed is:

1. A degassing apparatus comprising:
a preheater;
a degas column configured to contain beer and having a top and a bottom, wherein the preheater is in fluid communication with the top of the degas column;
a degas condenser in fluid communication with top of the degas column;
a condensate receiver in fluid communication with the degas condenser;
a degas condensate pump in fluid communication with the condensate receiver and the top of the degas column; and
a first pump in fluid communication with the bottom of the degas column and configured to pump fluid from the bottom of the degas column to the preheater.

2. The apparatus of claim 1, further comprising:
a second pump in fluid communication with the bottom of the degas column; and
a reboiler in fluid communication with the second pump and the bottom of the degas column;
wherein the second pump is configured to circulate fluid between the bottom of the degas column and the reboiler.

3. A degassing system for removing carbon dioxide from beer, comprising:
a beer column with an inlet and an outlet;
a degassing module comprising:
a preheater with a first line with an inlet and an outlet and a second line with an inlet and an outlet, wherein the first line inlet is in fluid communication with the beer column outlet and a second line outlet is in fluid communication with the beer column inlet;
a degas column configured to contain beer and having a top and a bottom, wherein the first line outlet is in fluid communication with the top of the degas column;
a degas condenser in fluid communication with top of the degas column;
a condensate receiver in fluid communication with the degas condenser;
a degas condensate pump in fluid communication with the condensate receiver and the top of the degas column; and
a first pump in fluid communication with the bottom of the degas column and configured to pump fluid from the bottom of the degas column to the second line inlet of the preheater;
a carbon dioxide scrubber in fluid communication with the degas condenser; and
a heat source in thermal communication with the bottom of the degas column.

4. The system of claim 3, wherein the heat source in thermal communication with the bottom of the degas column comprises:
a steam source in fluid communication with the bottom of the degas column.

5. The system of claim 3, wherein the heat source in thermal communication with the bottom of the degas column comprises:
a second pump in fluid communication with the bottom of the degas column; and
a reboiler in fluid communication with the second pump and the bottom of the degas column; and
a steam source in fluid communication with the reboiler;
wherein the second pump is configured to circulate fluid between the bottom of the degas column and the reboiler.

6. A degassing apparatus comprising:
a preheater;
a degas column configured to contain beer and having a top and a bottom, wherein the preheater is in fluid communication with the top of the degas column;
a degas condenser in fluid communication with top of the degas column and disposed above the top of the degas column; and
a first pump in fluid communication with the bottom of the degas column and configured to pump fluid from the bottom of the degas column to the preheater.

7. The apparatus of claim 6, further comprising:
a second pump in fluid communication with the bottom of the degas column; and
a reboiler in fluid communication with the second pump and the bottom of the degas column;
wherein the second pump is configured to circulate fluid between the bottom of the degas column and the reboiler.

8. A degassing system for removing carbon dioxide from beer, comprising:
a beer column with an inlet and an outlet;
a degassing module comprising:
a preheater with a first line with an inlet and an outlet and a second line with an inlet and an outlet, wherein the first line inlet is in fluid communication with the beer column outlet and a second line outlet is in fluid communication with the beer column inlet;
a degas column configured to contain beer and having a top and a bottom, wherein the first line outlet is in fluid communication with the top of the degas column;
a degas condenser in fluid communication with top of the degas column and disposed above the top of the degas column; and
a first pump in fluid communication with the bottom of the degas column and configured to pump fluid from the bottom of the degas column to the second line inlet of the preheater;
a carbon dioxide scrubber in fluid communication with the degas condenser; and
a heat source in thermal communication with the bottom of the degas column.

9. The system of claim 8, wherein the heat source in thermal communication with the bottom of the degas column comprises:
a steam source in fluid communication with the bottom of the degas column.

10. The system of claim 8, wherein the heat source in thermal communication with the bottom of the degas column comprises:
a second pump in fluid communication with the bottom of the degas column; and
a reboiler in fluid communication with the second pump and the bottom of the degas column; and
a steam source in fluid communication with the reboiler;
wherein the second pump is configured to circulate fluid between the bottom of the degas column and the reboiler.

11. A method for degassing beer, comprising the steps of:
heating beer a preheater;
separating the beer into vapor and liquid phases in a degas column, the degas column having a top and a bottom;
removing the vapor phase from the top of the degas column to a degas condenser;
condensing a part of the vapor phase in the degas condenser;
returning the condensed part of the vapor phase to the top of the degas column;
removing the uncondensed part of the vapor phase to a carbon dioxide scrubber;
pumping the liquid phase from the bottom of the degas column to the preheater;
extracting heat from the liquid phase the preheater; and
adding heat to the bottom of the degas column of the degas column.

12. The method of claim 11, wherein the step of returning the condensed part of the vapor phase to the top of the degas column comprises:
collecting the condensed part of the vapor phase from the degas condenser in a condensate receiver; and
pumping the condensed part of the vapor phase from the condensate receiver to the top of the degas column.

13. The method of claim 11, wherein the step of adding heat to the bottom of the degas column comprises:
adding steam to the bottom of the degas column.

14. The method of claim 11, wherein the step of adding heat to the bottom of the degas column comprises:
adding steam to a reboiler;
circulating liquid between the bottom of the degas column and the reboiler; and
removing condensed water from the reboiler.
